(19) United States
(12) Patent Application Publication
(10) Pub. No.: US 2024/0218950 A1
(43) Pub. Date: Jul. 4, 2024

(54) LINE CONNECTOR WITH LOW RESISTANCE

(71) Applicant: TI Automotive (Fuldabrueck) GmbH, Fuldabrueck (DE)

(72) Inventors: Iris BARTHEL, Schauenburg (DE); Michael ROEDER, Zierenberg (DE); Reiner ROHDE, Malsfeld (DE); Hans JENSEN, Dettingen unter Teck (DE); Andre HAECKEL, Waldeck (DE); Kay BUBE, Schenklengsfeld (DE)

(21) Appl. No.: 18/403,898

(22) Filed: Jan. 4, 2024

(30) Foreign Application Priority Data
Jan. 4, 2023 (EP) 23150315.2

(51) Int. Cl. F16L 37/35; F16L 37/12

(52) U.S. Cl. CPC F16L 37/35; F16L 37/1225

(57) ABSTRACT

A line connector for fluidic coupling with a complementary line connector comprises a connecting body. A valve is arranged in an internal channel, wherein the valve has a valve guide, an axially movable valve body, and a valve seat. The valve guide defines the movement direction of the valve body, wherein the line connector is designed such that the valve body rests in a fluid-tight manner on the valve seat in a locked state of the valve. It is provided that the valve seat has at least one flow aperture which in cross section deviates from a circular shape arranged concentrically with respect to the central axis M, and/or the valve guide is mounted to slide axially in a guide receptacle of the valve seat.

### RELATED APPLICATIONS

The present disclosure is a national phase application of European Application 23150315.2, filed on Jan. 4, 2023, the entire contents of which is incorporated herein by reference.

### FIELD

The disclosure relates to a line connector for fluidic coupling with a complementary line connector, wherein a valve is arranged in the internal channel.

### BACKGROUND

These types of line connectors in the form of a coupling socket and in the form of a coupling plug are known, for example, from GB 868,631 A or DE 10 2004 026 209 B4, wherein the line connectors respectively have a valve. By mating the two line connectors into a coupling arrangement, the valve located in the respective line connector is pressed by the respective other valve farther into the interior of the respective line connector, by which means both valves are simultaneously opened. In the case of a detachment of the coupling arrangement, the two valves are automatically closed with the aid of a respective reset element in the valve structure, so that fluid losses are prevented or strongly reduced during detachment of the coupling arrangement. The valves consequently open and close only as a function of the connection state of the coupling arrangement, so that these valves are independent of flow or fluid pressure.

However, we have found that the line connectors of this prior art have the disadvantage with respect to line connectors without valves, in that the flow resistances are quite high due to the valves.

### BRIEF SUMMARY

The present disclosure provides a line connector with a valve which has a lower flow resistance.

The line connector for fluidic coupling has a complementary line connector, wherein the line connector comprises a connecting body, wherein the connecting body has a connecting section for connecting to a pipe or to an aggregate and a coupling section for coupling with a complementary line connector, wherein the coupling section and the connecting section are fluidically connected to each other via an internal channel of the connecting body. The internal channel assigned to the coupling section defines a central axis in a longitudinal direction of the coupling socket and also an axial and a radial direction and also a circumferential direction, wherein the coupling section is concluded in the axially outward direction by a coupling opening. A valve is arranged in the internal channel, wherein the valve comprises a valve guide, an axially movable valve body, and a valve seat, wherein the valve guide defines the movement direction of the valve body, wherein the line connector is designed such that the valve body rests in a fluid-tight manner on the valve seat in the locked state of the valve and does not rest on the valve seat in the open state of the valve, characterized in that the valve seat has at least one flow aperture which in cross section or in a front view deviates from a circular shape arranged concentrically with respect to the central axis, and/or the valve guide is mounted to slide axially in a guide receptacle of the valve seat.

The disclosure is initially based on the recognition that the problem listed at the outset may be solved by two different solutions, wherein the two solutions may also be cumulatively used.

According to the first solution, the object listed at the outset is completed in that at least one flow aperture of the valve seat deviates from the concentric circular shape. For example, the flow aperture may be designed as star or flower shaped, by which means the periphery of the flow aperture is significantly enlarged with respect to the concentric circular shape. As soon as the valve body, advantageously designed complementary to the valve seat or to the flow opening, detaches from the valve seat, a flow channel is established in the valve, which in the case of the two listed exemplary shapes substantially has the outline of a star or a flower. Admittedly, the fluid flows virtually only on the outer edge of the respective flow aperture because the valve body initially detaches from the valve seat there. As a result, the area of the flow opening is less decisive with respect to the flow rate or the flow resistance than the periphery of the flow opening.

Furthermore, the flow resistance may also be thereby significantly reduced in that the valve seat has two or more flow apertures, which largely divide the total surface of the valve seat among themselves. This is because the sum of the peripheries of the individual flow apertures is greater than the periphery of one single large flow aperture. If, for example, two or three circular flow apertures are provided in the valve seat, then this is indeed circular shaped, which, however, are not arranged concentrically with respect to the central axis M. As a result, flow apertures, which are either not circular shaped, or flow openings, which are circular, however not arranged concentrically, enable a reduction of the flow resistance, by which means the valve has a lower flow resistance.

According to the second solution, the object listed at the outset is completed in that the valve guide is mounted to slide axially in a guide receptacle of the valve seat. By this means, a valve holder, in which the valve guide of the known valves is held or mounted, may be omitted on the axially inward side of the valve body. This valve holder is connected in turn to an inner wall of the line connector via webs, which generate a flow resistance. By integrating the function of the valve holder into the valve seat or the mounting/holder of the valve guide in the valve seat, a separately designed valve holder in the interior channel is omitted. As a result, the flow resistance is reduced and the problem listed at the outset is solved.

The expression “axially inward” preferably means the axial direction away from the coupling opening of the line connector or of the complementary line connector farther into the line connector or the complementary line connector or up to the connecting section. The specification “axially inward” or “axially outward” advantageously relates in each case to the line connector, so that the axially inward direction of the line connector is opposite to the axially inward direction of the complementary line connector.

The expression “to slide axially” preferably means that only a minor amount of necessary radial play is present for axial sliding. It is possible that the valve guide and the valve seat are designed such that a rotation of the valve guide in the valve seat is prevented. This contributes to a particularly reliable sealing effect.

The valve guide is advantageously designed as elongated and preferably designed as rod-shaped. A longitudinal extension or the longest extension of the valve guide preferably extends in the axial direction. This enables a design of the valve with a lowest possible resistance. It is preferred that the valve guide, the valve body, and/or the valve seat is/are designed as rotationally symmetrical at least in axial sections and/or is/are arranged concentrically. The valve seat, at least in axial sections, is advantageously arranged axially farther outward than the valve body in the open state and/or in the closed state of the valve. The valve seat and/or the valve body is/are advantageously completely housed within the connecting body in the radial direction and/or in the axial direction.

The valve seat preferably comprises a valve seat ring, wherein the valve seat ring further preferably forms an outer edge of the valve seat. The valve seat is advantageously produced as one piece and preferably integrally, for example, using injection molding. The valve seat advantageously comprises the guide receptacle for mounting the valve guide. The valve seat advantageously comprises at least one valve seat web, which connects the guide receptacle to the valve seat ring.

The at least one valve seat web tapers advantageously in a longitudinal direction of the line connector in the axially inward/and/or axially outward direction, preferably in the axially inward and in the axially outward directions. In the axial direction, the at least valve seat web advantageously has a central section in a longitudinal direction of the line connector, wherein in the radial direction, the central section is further extended in an axially outward section and/or an axially inward section of the valve seat web. The fluid flow is optimized by this means.

A contour or a cross section of the at least one valve seat web is advantageously rounded in a longitudinal direction of the line connector, is preferably designed as droplet shaped in at least one axial direction, and is particularly preferably designed as droplet shaped in both axial directions.

According to one preferred embodiment, the valve seat has at least two or three—preferably only two—flow apertures each with complete peripheral edges. It is preferred that the flow apertures form at least two or three valve seat webs. The valve seat advantageously has at least two or three valve seat webs. The valve seat webs advantageously connect a/the flow aperture to the valve seat ring.

According to one preferred embodiment, the at least one or only one flow aperture deviates from the circular shape. The at least one flow aperture may, for example, be configured as flower or star shaped. It is possible that at least one valve seat web runs farther radially inward, starting from the valve seat ring, wherein a radially inner end of the valve seat web preferably forms a/the guide receptacle.

It is particularly preferred that the at least one flow aperture—preferably the two flow apertures—is/are elongated or arched in a cross section or in a front view. This enables the enlargement of the total peripheral length of the flow apertures and simultaneously contributes to the omission of a separate valve holder. The at least one flow aperture or the two flow apertures is/are advantageously designed as C-shaped. It is preferred that the two flow apertures at least partially surround the guide receptacle in a front view due to the arched or C-shaped contour.

The valve body preferably comprises a sealing surface which rests in a fluid-tight manner on the valve seat or on the at least one flow aperture in a closed state of the valve. In the closed state of the valve, an edge of the at least one flow aperture engages into the sealing surface in the axial direction. This contributes to the reduction of the flow resistance or to the sealing effect of the valve. It is preferred that the valve body or the sealing surface has a valve seat receptacle in the open state of the valve. The valve seat receptacle preferably comprises at least one web receptacle for accommodating a valve seat web and/or a receptacle for the guide receptacle of the valve seat.

It is preferred that an axially outward end of the valve guide projects past the valve seat or the guide receptacle in an axially outward direction. It is advantageous that the valve body is connected to the valve guide with its side assigned to the coupling opening or with its axially outward side. This contributes to the omission of a separate valve holder. An axially inward end of the valve guide is preferably connected to the valve body. It is advantageous that the axially outward end of the valve guide projects axially farther in the outward direction past the valve seat in a closed state of the valve in comparison to an open state of the valve.

According to a preferred embodiment, the valve seat is produced separately from the connecting body and is fixed in the connecting body or in a valve seat section of the connecting body. This enables the integral design of the connecting body so that it does not require, in particular, a connecting body produced from two or more parts. The valve seat may be fixed in the connecting body in a non-positive locking, positive locking, and/or materially bonded manner, wherein the valve seat is advantageously fixed into the connecting body in a non-positive locking and/or positive locking manner. The valve seat may, in particular, be clamped into the connecting body or into the valve seat section, wherein the clamping force acts preferably in the radial direction. The valve seat ring of the valve seat is advantageously designed on its radially outer side to be complementary to a valve seat section of the connecting body and is inserted into the valve seat section. The valve seat section may have a shoulder projecting radially inward for defining an axial position of the valve seat within the connecting body.

The valve preferably comprises a reset element, wherein the reset element is preferably arranged axially outward from the valve seat or from the guide receptacle. It is advantageous that the reset element exerts a force on the valve body—preferably in the direction of the valve seat—so that the reset element presses the valve body against the valve seat in the closed state of the valve. It is preferred that the reset element or an inward end of the reset element is mounted on an axial outer side of the valve seat or an axial outer side of the guide receptacle. The reset element is advantageously configured as an elastic element, in particular as an elastic spring element, and preferably as a helical spring. It is preferred that the reset element surrounds the valve guide in the radial direction at least in axial sections. An axially outward end of the reset element is advantageously mounted on an axially outward end of the valve guide. The axially outward end of the valve guide advantageously comprises a projection projecting radially outward, which is preferably designed as a flange. The reset element is preferably arranged between the radially outward projecting projection on the axially outward end of the valve guide and the valve seat or the guide receptacle.

The line connector advantageously comprises a valve seat holder for securing the valve seat in the connecting body. The valve seat holder may be designed as ring shaped and preferably as circular ring shaped. The valve seat holder is preferably arranged axially outward relative to the valve seat. The valve seat holder may be fixed in the connecting body in a non-positive locking, positive locking, and/or materially bonded manner, and in particular be clamped into the connecting body. The valve seat holder advantageously prevents axial play of the valve seat in the connecting body.

According to one preferred embodiment, the connecting body is designed as one piece and is preferably integrally formed. This enables a particularly cost-efficient production. The connecting body may be configured as two parts, and, for example, comprise two parts connected to each other in a non-positive locking and/or positive locking manner. It is possible that a one-piece connecting body has two separately produced parts, which were connected to one another via material bonding, in particular via welding.

The valve body, the valve seat, the valve holder and/or the connecting body advantageously comprise(s) a plastic material or largely comprise(s) a plastic material. The reset element preferably contains a metal, and further preferably largely contains a metal. The material of the valve body or the sealing surface of the valve body is advantageously softer than the material of the valve seat and/or the valve guide. The valve guide may contain or largely contain a metal and/or a plastic material.

It is preferred that the valve body does not contact the connecting body in the open state of the valve and/or in the closed state of the valve. This contributes to a low flow resistant valve. The valve body advantageously never contacts the connecting body at any time between the open and the closed state of the valve. The connecting body is preferably exclusively guided via the valve guide during the transition from the closed state into the open state and vice versa. The valve body preferably surrounds the valve guide at least axially in sections and at least partly in the radial direction and preferably across an entire revolution.

According to one preferred embodiment, the valve body in the closed state of the valve is connected to the connecting body—preferably only connected—via the valve seat. An axially inward end of the valve or the valve body is preferably free from elements which connect the valve or the valve body to the connecting body. It is preferred that the line connector has no other valve holder in addition to the valve seat. This reduces the flow resistance and reduces the number of parts.

The valve or the line connector is preferably designed such that the valve opens or closes depending on a connection of the line connector with a complementary line connector. The valve or the line connector is advantageously configured such that the valve opens in the case of a complete connection to a complementary line connector, in particular in the case of a latching of the complementary line connector in the line connector. The valve or the line connector is advantageously designed such that the valve opens or closes regardless of a flow direction and/or a fluid pressure in the interior channel.

The valve is advantageously designed such that an area of the valve body lying radially farther inward in the open state is axially spaced equally far from the valve seat as an area of the valve lying radially farther outward. This is an important distinction from flexible, for example, membrane like valves, in which radially outer areas are pushed farther away from the valve seat by the fluid than areas lying radially farther inward.

In the longitudinal direction, the valve body preferably comprises a radially expanding section in the axially outward direction and a radially tapering section in the axially outward direction. The tapering section may be arranged axially farther outward than the expanding section. This contributes to the reduction of the flow resistance.

The line connector may be a coupling socket or a coupling plug. The coupling socket is advantageously designed such that a complementary line connector in the form of a coupling plug is insertable into the coupling socket in a fluid-tight manner. The coupling plug is advantageously designed such that the coupling plug is insertable into a complementary line connector in the form of a coupling socket in a fluid-tight manner. The coupling socket advantageously comprises a retainer for—preferably reversible—holding of the coupling plug in the coupling socket. The retainer advantageously engages in a non-positive locking with the coupling plug. The retainer is preferably designed as a latching element, so that, during insertion into the coupling socket, the coupling plug engages into a—preferably reversible—latching connection with the retainer. The retainer may be configured, for example, as U-shaped or circumferential. The retainer may comprise a metal and/or a plastic material.

A fluid line may comprise at least one line connector according to the disclosure and a pipe. The fluid line may comprise two line connectors, wherein one line connector is respectively advantageously fastened on one of the two ends of the pipe. The pipe is preferably connected in a non-positive locking, positive locking, and/or materially bonded manner to the connecting section of the line connector. The pipe may be connected to the line connector, in particular in a non-positive locking and positive locking manner, for example using a press fitting, preferably by means of pushing onto the connecting section. According to one preferred embodiment, the pipe is fastened to the line connector or to the connecting section by means of material bonding and preferably by means of welding and particularly laser welding. The pipe is particularly preferably inserted into the connecting section and connected to the connecting section or to the line connector by means of friction welding or laser welding—preferably laser welding.

The problem listed at the outset is solved by a use of a line connector, in particular a line connector according to the disclosure, in a motor vehicle, in particular in a land vehicle or a road vehicle, and preferably in a passenger vehicle or a commercial vehicle, wherein the use is preferably in an electric vehicle.

### BRIEF DESCRIPTION OF THE DRAWINGS

The disclosure will be subsequently depicted by way of multiple exemplary embodiments with the aid of multiple figures. As shown in:

FIG. 1 a perspective view of a coupling arrangement with a line connector according to the disclosure and a complementary line connector according to the disclosure,

FIG. 2 a longitudinal sectional view through the coupling arrangement from FIG. 1 in a connected state and with open valves,

FIG. 3 a longitudinal sectional view through the coupling arrangement from FIGS. 1 and 2 in an only partially connected state and with closed valves,

FIG. 4A a perspective view of a valve seat according to the disclosure and a valve body according to the disclosure of the valves from FIGS. 2 and 3 in an exploded view,

FIG. 4B a front view of the valve seat and the valve body from FIG. 4A,

FIG. 5 a front view of a valve seat of a second exemplary embodiment of the disclosure,

FIG. 6 a front view of a valve seat according to the disclosure of a third exemplary embodiment of the disclosure,

FIG. 7 a front view of a valve seat according to the disclosure of a fourth exemplary embodiment of the disclosure.

### DETAILED DESCRIPTION

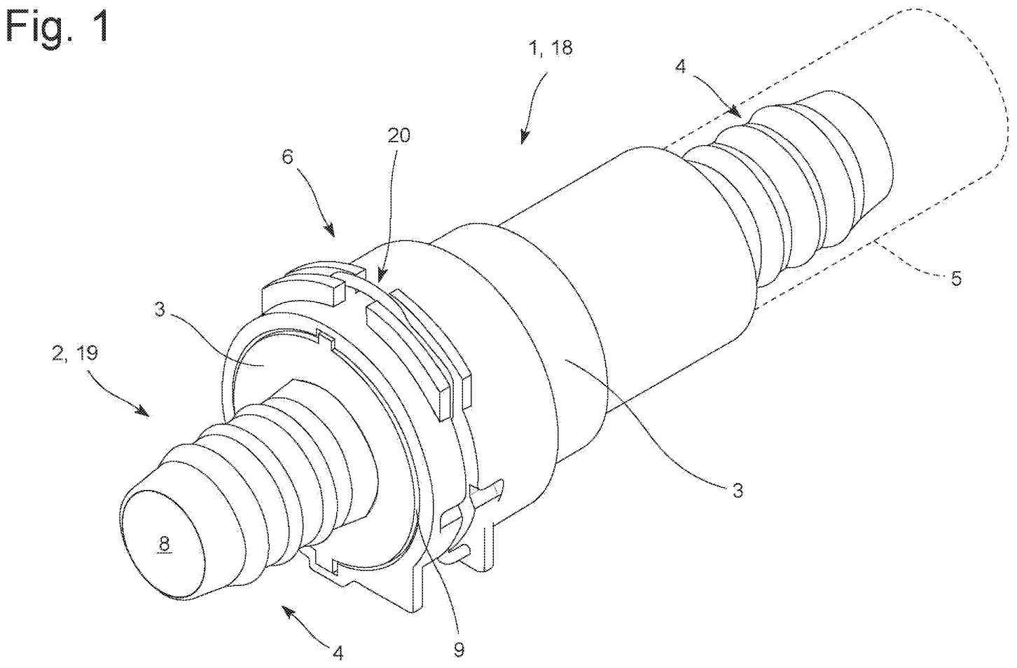

A coupling arrangement 1, 2 of a first exemplary embodiment of the disclosure is shown in FIG. 1. Coupling arrangement 1, 2 comprises a first line connector 1 in the preferred form of a coupling socket 18 and a second or complementary line connector 2 in the preferred form of a coupling plug 19. Both line connector 1 and also complementary line connector 2 are designed as VDA line connectors in this exemplary embodiment. Line connector 1 and/or complementary line connector 2 has/have a connecting body 3. Line connector 1 of this exemplary embodiment further comprises a retainer 20.

Retainer 20 of this exemplary embodiment is designed as a wire strap, which is configured as U-shaped or substantially U-shaped. Two U legs of retainer 20 project preferably into an interior of connecting body 3 and latch there, preferably in or on a latching element—known per se and not visible in the figures due to the selected perspective views—of complementary line connector 2. The latching element may be designed as a groove or shoulder. It is preferred that, during an insertion of complementary line connector 2 into line connector 1, complementary line connector 2 spreads the U legs of retainer 20 apart until the latching element has reached the U legs and these latch in there.

Line connector 1 and/or complementary line connector 2 comprise(s) a connecting section 4 for connecting to a pipe 5 or to an aggregate. The aggregate may be, for example, a tank, a pump, a nozzle or the like. Connecting section 4 may be connected in a non-positive locking, materially bonded, and/or positive locking manner to pipe 5 or to the aggregate. It is possible that connecting section 4 is connected as one piece and is preferably integrally connected to the aggregate. In particular, it is possible that line connector 1 or line connector 2 is overmolded—in particular via injection molding—onto the aggregate via connecting section 4.

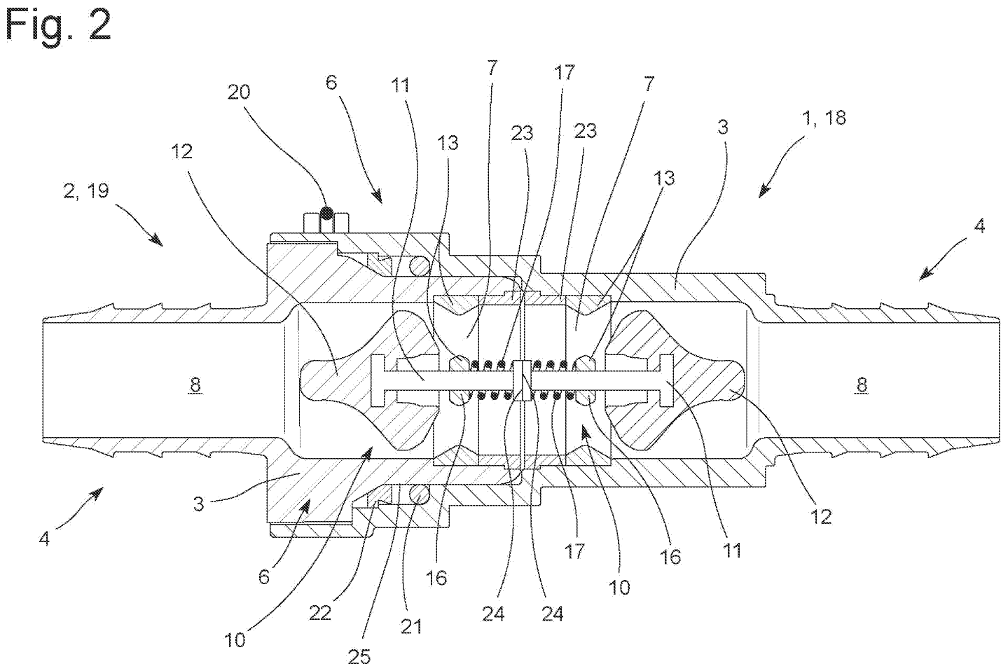

Line connector 1 comprises a coupling section 6 for coupling with complementary line connector 2. Complementary line connector 2 advantageously comprises a coupling section 6 (see FIG. 2), which is designed for coupling with line connector 1. The expression “coupling section” preferably means the respective section overlapping with the other line connector 1, 2 in the axial direction. Connecting section 4 and/or coupling section 6 is/are advantageously component(s)—preferably one piece components and particularly preferably integral components—of connecting body 3 of line connector 1 or complementary line connector 2. It is preferred that connecting body 3 of line connector 1 or of complementary line connector 2 is designed as one piece and is preferably integrally designed.

It is clear in FIG. 2 that connecting section 4 of line connector 1 or of complementary line connector 2 is fluidically connected to coupling section 6 of line connector 1 or complementary line connector 2 via an internal channel 8 of line connector 1 or complementary line connector 2. Line connector 1 advantageously comprises a seal 21, 22, which preferably comprises a sealing ring 21 and further preferably a sealing ring holder 22. With the aid of seals 21, 22, internal channels 8 of line connector 1 and complementary line connector 2 are connected to each other in a fluid-tight manner.

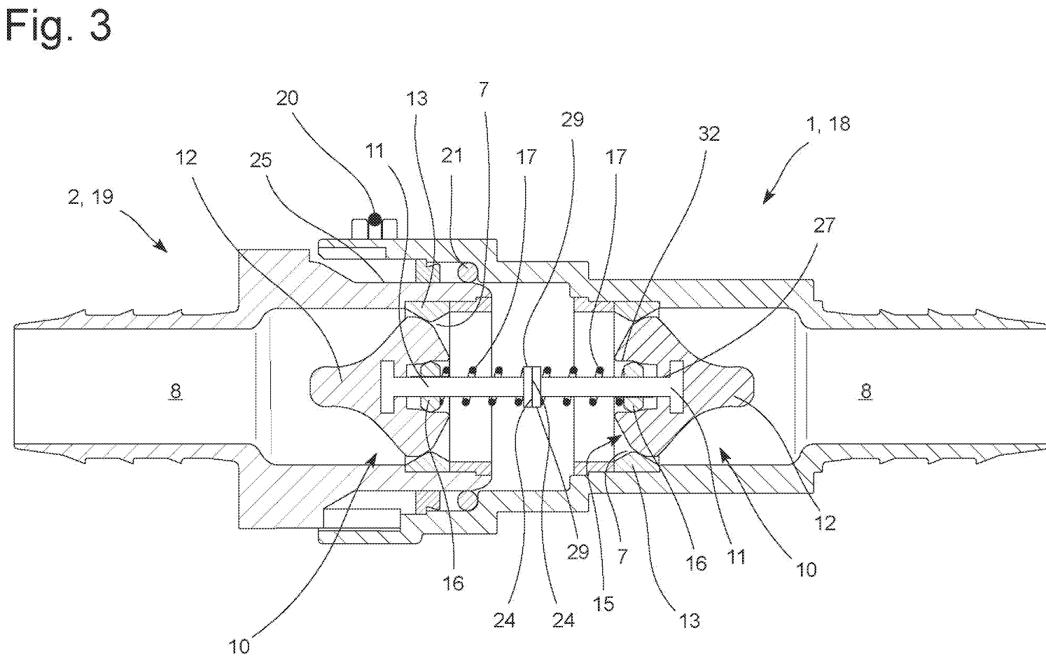

Complementary line connector 2 of this exemplary embodiment comprises a coupling surface 25 in its coupling section 6, which coupling surface is advantageously designed as cylindrical, complementary to coupling section 6 of line connector 1, and in particular enters into a fluid-tight non-positive locking and positive locking connection with sealing ring 21, see FIG. 3. Coupling arrangement 1, 2 or line connector 1 or line connector 2 is advantageously designed such that coupling surface 25 contacts sealing ring 21 before valve(s) 10 is/are opened, compare FIGS. 2 and 3.

A valve 10 in line connector 1 and/or a valve 10 in complementary line connector 2 is preferably opened by the complete insertion of complementary line connector 2 into line connector 1. In this exemplary embodiment, valve 10 of line connector 1 and valve 10 of complementary line connector 2 are identically designed, so that only the design of valve 10 of line connector 1 is subsequently described.

Valve 10 of line connector 1 comprises a valve guide 11, a valve body 12, and a valve seat 13. Valve 10 preferably comprises a reset element 17, which is designed in this exemplary embodiment as a helical spring. Valve 10 advantageously has a valve seat holder 23, which holds of fixes valve seat 13 in line connector 1 or in connecting body 3. Valve seat holder 23 may be designed as approximately ring shaped, arranged axially outwardly relative to valve seat 13, and/or fastened in connecting body 3 in a non-positive locking, materially bonded, and/or positive locking manner. Valve seat 13 is advantageously arranged in a valve seat section of connecting body 3. The valve seat section may have a shoulder projecting radially inward in a longitudinal direction, which shoulder defines an axial position of the valve seat.

Valve guide 11 of this exemplary embodiment is designed as elongated and preferably comprises a pressure surface 24 on its axially outward end. Pressure surface 24 faces a/the complementary line connector 2 and is preferably designed to contact a pressure surface 24 of a valve guide 11 of valve 10 of complementary line connector 2. Pressure surface 24 is advantageously a component or an axial outer side of valve guide 11 or a projection or a pressure collar 29 of valve guide 11.

In FIG. 3, complementary line connector 2 is inserted so far into line connector 1 that both pressure surfaces 24 just touch so that the compression forces acting on reset elements 17 equal zero. Due to a further insertion of complementary line connector 2 into line connector 1, both reset elements 17 are further compressed due to increasing compression forces, by which means an increasingly larger reset energy is stored in respective reset element 17. Reset elements 17 each support themselves with an axially outward end preferably on a respective pressure collar 29, which preferably simultaneously forms respective pressure surface 24.

Reset element 17 is supported by valve seat 13 on the axially inward side of respective reset element 17 in FIGS. 2 and 3. It is preferred that valve seat 13 has a guide receptacle 16 in which valve guide 11 is mounted to be axially movable. It is preferred that reset element 17 presses in the axial outward direction against pressure collar 29 of valve guide 11 so that valve body 12 is advantageously pulled against valve seat 13 in the axially outward direction. In the open or not connected state of coupling arrangement 1, 2, valve body 12 thus advantageously contacts valve seat 13, so that valve 10 is closed, see FIG. 3.

Due to the further insertion, based on FIG. 3, reset element 17 is compressed, by which means valve guide 11 and valve body 12 of this exemplary embodiment are moved farther axially inward and by this means valve body 12 is detached from valve seat 13, see FIG. 2. Complementary line connector 2 thereby latches on retainer 20, by which means a mechanical securing and a fluidic opening take place approximately simultaneously. Conversely, upon detaching of coupling arrangement 1, 2, a fluidic closing of both valves is achieved so that the fluid loss is minimized during detaching of coupling arrangement 1, 2.

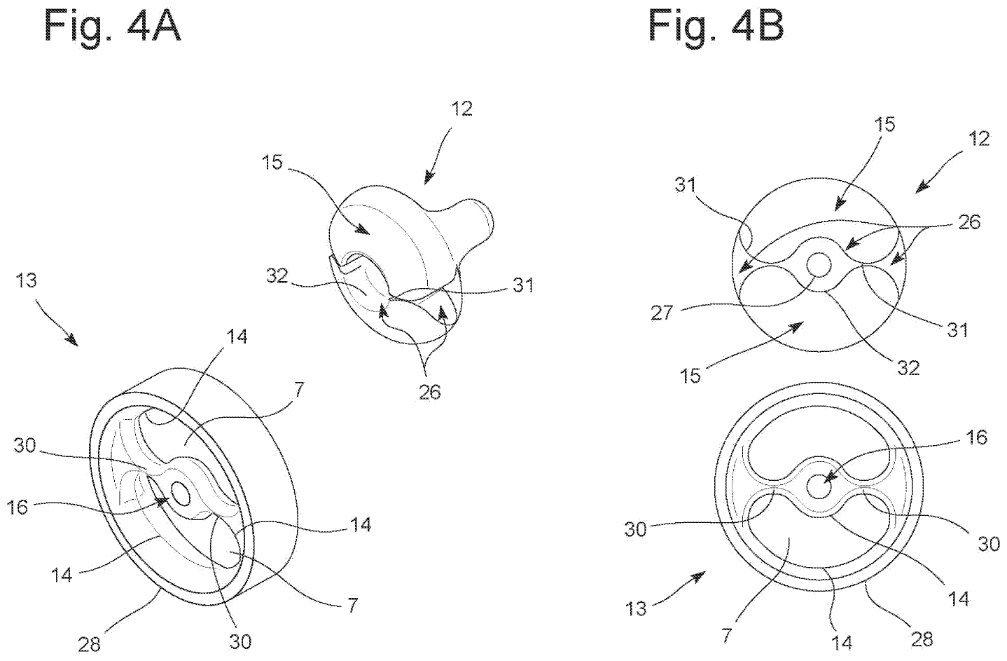

Valve seat 13 and associated, complementarily configured valve body 12 are depicted in FIG. 4A in perspective and in an exploded view to one another. Valve seat 13 of this exemplary embodiment comprises two flow apertures 7, which are preferably designed as elongated and/or preferably arched and/or configured in particular in a C-shape. Flow apertures 7 are each delimited by an edge 14. Valve seat 13 and valve body 12 from FIG. 4A are respectively depicted in a front view in FIG. 4B.

A guide receptacle 16, which mounts respective valve guide 11 to be movable in the axial direction, is preferably arranged between both flow apertures 7 from FIGS. 4A, 4B. Guide receptacle 16 is preferably connected to the remaining body of valve seat 13 via two valve seat webs 30. Valve seat 13 advantageously comprises a valve seat edge 28, which is advantageously designed as ring shaped, and in particular as circular ring shaped. Valve seat edge 28 is preferably connected to guide receptacle 16 via valve set webs 30. Valve seat webs 30 of this exemplary embodiment are flow optimized according to FIG. 4A and taper in the axially inward and also in the axially outward direction.

Guide receptacle 16 of the exemplary embodiment according to FIGS. 4A, 4B is a through hole, which is preferably arranged concentric to central axis M. Guide receptacle advantageously allows a movement of valve guide 11 in the axial and circumferential directions, however not—with the exception of minor play—in the radial direction. It is possible that guide receptacle 16 and/or valve guide 11 and/or valve 10 is/are designed such that the movement direction of valve guide 11 in guide receptacle 16 is prevented in the circumferential direction. By this means, it is guaranteed that valve body 12 is always axially moved exactly or in the correct alignment toward valve seat 13.

Valve body 12 of the exemplary embodiment according to FIGS. 4A, 4B comprises an elastomer or consists of an elastomer. Valve seat 13 preferably contains a plastic material, in particular a plastic material without an elastomer component. The material of valve body 12 is advantageously softer than the material of valve seat 13, so that a particularly good seal is advantageously achieved between valve seat 13 and valve body 12. It is possible in other exemplary embodiments, not depicted here, that the valve body is coated with an elastomer coating.

Valve body 12 advantageously comprises a sealing surface 15, which is preferably arranged in an axially outward area of valve body 12, see FIGS. 4A, 4B. Sealing surface 15 is preferably that surface of valve body 12 which seals flow apertures 7 of valve seat 13. Due to the two flow apertures 7 of valve seat 13, according to the exemplary embodiment according to FIG. 4A, sealing surface 15 of valve body 12 has two sections, wherein each of the two sections is advantageously assigned to respectively one of the two flow apertures 7.

In an axially outward area, valve body 12 according to FIGS. 4A, 4B preferably comprises a valve seat receptacle 26, into which valve seat 13 engages in the case of a closed valve 10. Valve seat receptacle 26 preferably comprises a valve guide receptacle 27 and, preferably, two web receptacles 31. Valve body 12 may have a receptacle 32 for guide receptacle 16. As is clear in particular from FIGS. 2 and 3, valve guide receptacle 27 and receptacle 32 for guide receptacle 16 preferably partially coincide. Receptacle 32 for guide receptacle 16 of valve seat 13 is thereby arranged inside of valve body 12, advantageously farther axially outward than valve guide receptacle 27 of valve body 12, see FIGS. 2, 3.

Valve guide receptacle 27 performs the function of fastening valve body 12 to valve guide 11. In contrast, receptacle 32 for guide receptacle 16 performs the task of enlarging the axial overlap between valve body 12 and valve seat 13 so that the seal between valve body 12 and valve seat 13 is facilitated. Receptacle 32 enables in particular a particularly aerodynamic design of valve body 12. Thus, it is clear from the longitudinal sectional views of FIGS. 2 and 3 that sealing surface 15 or the two sections of sealing surface 15 expand(s) radially, starting from receptacle 32 in the axially inward direction. By this means, it is achieved that the fluid does not strike a nearly vertical wall, so that flow turbulences are reduced and the flow resistance is kept as low as possible. Farther in the axially inward direction, and thus axially behind the sealing surface, valve body 12 preferably tapers and concludes at its axially inward, advantageously rounded end. Due to the design of valve body 12, a flow path within coupling arrangement 1, 2 is created with as little resistance as possible over all.

The flow behavior of valve 10 may be explained well with a view of FIG. 4B. In the closed state of valve 10, sealing surface 15 or the two sections of sealing surface 15 is/are located in two flow apertures 7 of valve seat 13 in a fluid-tight manner. In turn, guide receptacle 16 and valve seat webs 30 of valve seat 13 are seated in valve seat receptacle 26 of valve body 12. In the moment that sealing surface 15 detaches from flow aperture 7, the fluid flows through flow aperture 7 along the periphery of flow aperture 7. Thus, the active flow surface in the first moment of opening virtually corresponds to the peripheral line of the C-shape of the two flow apertures 7 from FIG. 4B. If valve body 12 is pushed a little bit farther axially inward, then the active flow surface expands, so that the active flow surface no longer corresponds to a thin line, but instead to a thick line along the periphery of the two flow apertures 7. In particular, a flow in a center area of the two flow apertures 7 scarcely occurs in FIG. 4B, as the flow is primarily present at edge 14 of flow apertures 7. With regard to fluids, the inner areas of flow apertures 7 are to be virtually disregarded. As the peripheral length of the two flow apertures 7 is significantly larger than the peripheral length of a single circular flow aperture, not depicted here, the circular flow aperture has a significantly lower peripheral length and thus also a significantly larger flow resistance.

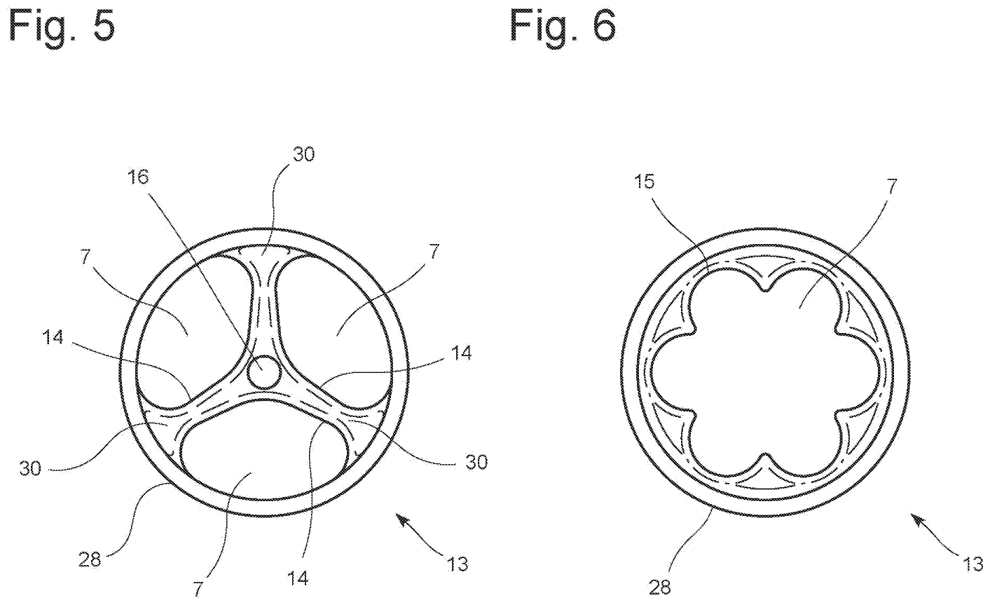

A second exemplary embodiment of a valve seat 13 is shown in a front view in FIG. 5. Valve body 12 of this exemplary embodiment is not shown, as it is designed complementary to valve seat 13 and in other respects has the design of valve body 12 according to the exemplary embodiment of FIGS. 4A and 4B. Valve seat 13 of the second exemplary embodiment comprises three flow apertures 7, which may be the same size and the same shape. Valve seat 13 of the exemplary embodiment according to FIG. 5 advantageously comprises a guide receptacle 16, which is preferably arranged concentrically to central axis M and mounts valve guide 11 to be movable in the axial direction. The three flow apertures 7 according to FIG. 5 are advantageously separated from each other by a respective valve seat web 30, wherein valve seat webs 30 advantageously merge in a central area in a front view of valve seat 13 and form guide receptacle 16. In addition, valve seat edge 28 of the second exemplary embodiment is configured identically to the first exemplary embodiment.

A third exemplary embodiment of valve seat 13 is shown in FIG. 6, wherein valve seat edge 28 may be again identical to those of the two preceding exemplary embodiments. Valve seat 13 of the third exemplary embodiment comprises only one flow aperture 7, which deviates from a circular shape and may have an undulating or flower-shaped contour. Due to the undulating or flower-shaped contour, the peripheral length of edge 14 of flow aperture 7 is enlarged, by which means the flow resistance is reduced with respect to a correspondingly ideal circular shape.

In the exemplary embodiment shown in FIG. 6, valve seat 13 comprises no guide receptacle. Consequently, valve body 12, not shown in FIG. 6, is designed fundamentally differently in comparison to valve body 12 of the first and second exemplary embodiments. It is possible, for example, that valve body 12 of the third exemplary embodiment has a valve guide arranged axially inwardly, which is mounted on a valve holder arranged ever farther axially inwardly, see, for example, GB 868,631. Thus, the third exemplary embodiment according to FIG. 6 shows that the idea of deviating from the circular shape is also applicable to conventionally mounted or held valves.

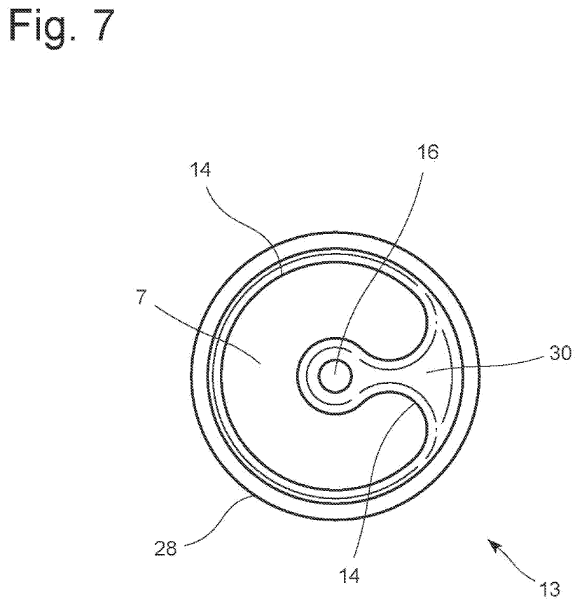

The fourth exemplary embodiment in FIG. 7 illustrates that a valve seat 13 is possible, which has only one flow aperture 7 and simultaneously a guide receptacle 16. In this exemplary embodiment, a valve seat web 30, designed to be correspondingly thick, holds guide receptacle 16, which projects into single flow aperture 7. Due to edge 14 in the area of valve seat web 13, the active flow surface is significantly increased with respect to a flow aperture with a purely circular shape, so that the exemplary embodiment shown in FIG. 7 also effects a reduction of the flow resistance with respect to conventional valves.

### LIST OF REFERENCE NUMERALS

1 Line connector
2 Complementary line connector
3 Connecting body
4 Connecting section
5 Pipe
6 Coupling section
7 Flow aperture
8 Internal channel
9 Coupling opening
10 Valve
11 Valve guide
12 Valve body
13 Valve seat
14 Edge of 7
15 Sealing surface of 12
16 Guide receptacle of 13
17 Reset element
18 Coupling socket
19 Coupling plug
20 Retainer
21 Sealing ring
22 Seal holder
23 Valve seat holder
24 Compression surface of 11
25 Coupling surface of 2, 19
26 Valve seat receptacle of 12
27 Valve guide receptacle of 12
28 Valve seat edge
29 Pressure collar of 11
30 Valve seat web of 13
31 Web receptacle of 12
32 Receptacle for 16 of 12

1. A line connector for fluidic coupling with a complementary line connector, wherein the line connector comprises a connecting body, wherein the connecting body has a connecting section for connecting to a pipe or to an aggregate and a coupling section for coupling with a complementary line connector,
wherein the coupling section and the connecting section are fluidically connected to each other via an internal channel of the connecting body, wherein the section of the internal channel assigned to the coupling section defines a central axis in a longitudinal direction of the coupling socket and also an axial and a radial direction and also a circumferential direction, wherein the coupling section is concluded in the axially outward direction by a coupling opening,
wherein a valve is arranged in the internal channel, wherein the valve comprises a valve guide, an axially movable valve body, and a valve seat, wherein the valve guide defines the movement direction of the valve body, wherein the line connector is designed such that the valve body rests in a fluid-tight manner on the valve seat in the locked state of the valve and does not rest on the valve seat in the open state of the valve,
wherein the valve seat has at least one flow aperture which in cross section or in a front view deviates from a circular shape arranged concentrically with respect to the central axis,
and/or
the valve guide is mounted to slide axially in a guide receptacle of the valve seat.

2. The line connector according to claim 1, wherein the valve seat has at least two flow apertures each with complete peripheral edges.

3. The line connector according to claim 1, wherein the at least one or only one flow aperture deviates from the circular shape.

4. The line connector according to claim 1, wherein the at least one flow aperture is elongated or arched in a cross section or in a front view.

5. The line connector according to claim 1, wherein the valve body has a sealing surface which rests in a fluid-tight manner on the valve seat or on the at least flow aperture in a closed state of the valve.

6. The line connector according to claim 1, wherein an axially outward end of the valve guide projects past the valve seat or the guide receptacle in an axially outward direction.

7. The line connector according to claim 1, wherein the valve seat is produced separately from the connecting body and is fixed in the connecting body or in a valve seat section of the connecting body.

8. The line connector according to claim 1, wherein the valve comprises a reset element, wherein the reset element is preferably arranged axially outward from the valve seat or from the guide receptacle.

9. The line connector according to claim 1, wherein the line connector comprises a valve seat holder for securing the valve seat in the connecting body.

10. The line connector according to claim 1, wherein the connecting body is designed as one piece and is integrally formed.

11. The line connector according to claim 1, wherein the valve body does not contact the connecting body in the open state of the valve and/or in the closed state of the valve.

12. The line connector according to claim 1, wherein the line connector is designed such that the valve opens or closes depending on a connection of the line connector with a complementary line connector.

13. The line connector according to claim 1, wherein line connector is a coupling socket or a coupling plug.

14. A fluid line comprising at least one line connector according to claim 1 and a pipe.

15. Use of a line connector according to claim 1 in an electric vehicle.
